(19) United States
(12) Patent Application Publication
(10) Pub. No.: US 2026/0213926 A1
(43) Pub. Date: Jul. 23, 2026

(54) COMPUTER IMPLEMENTED METHOD, COMPUTER SYSTEM, COMPUTER PROGRAM AND COMPUTER-READABLE STORAGE MEDIUM FOR PROVIDING PERSONAL DATA ANONYMOUSLY OR ASSIGN TO A PERSON

(71) Applicant: Xtendr ZRT., Budapest (HU)

(72) Inventor: Ferenc Vágujhelyi, Budapest (HU)

(21) Appl. No.: 19/142,473

(22) PCT Filed: Dec. 23, 2022
(86) PCT No.: PCT/HU2022/050092

§ 371 Date: Jun. 23, 2025

(51) Int. Cl. H04L 9/08

(52) U.S. Cl. CPC H04L 9/0825; H04L 9/0861

(57) ABSTRACT

The invention is a computer implemented method for providing either anonymously or in a person-attributed manner personal data, offered by data subjects (10), to data requesting entities (20). The method comprising the following: making available anonymous data records (100) to the data requesting entities (20) by collecting, in a data store (30), the anonymous data records (100) generated by the data subjects (10), making available data request records (101) to the data subjects (10) by also collecting, in a data store (30), the data request records (101) generated by the data requesting entities (20), and making available data provision records (102) to the data requesting entities (20), by also collecting, in a data store (30), the data provision records (102) generated by the data processing systems (11) . The invention is furthermore a computer system carrying out the above method, a computer program, and a computer-readable storage medium.

### TECHNICAL FIELD

The invention relates to a computer implemented method, to a computer system, to a computer program, and to a computer-readable storage medium for providing personal data, either anonymously or in a person-attributed manner. The invention relates in particular to the field of solutions allowing the analysis of data attributable to natural persons, wherein the data provision is performed with the consent of the data subject, or by removing the attribution by the data subject itself, i.e., applying a so-called “data wallet” solution.

### BACKGROUND ART

Nowadays, almost all events related to natural persons leave a “digital trace”, i.e., they produce a certain amount of data in the digital space. The data subject has the right to dispose of the data relatable to itself in that it may offer those for use to other entities engaged in data reuse, i.e., in exploiting the value inherent in the data by analytic methods (analyzing them together with a large amount of other data). Data protection regulations usually stipulate that the data subjects have the right to obtain free of charge, in a widely used electronic format, the data that are stored about them. For example, this is laid down in Paragraph (3), Article 15 of the General Data Protection Regulation of the European Union. This provides reasonable grounds to assume that the data subject is usually able to obtain the data stored about it, and can offer them to other parties for reuse.

The protection of personal data is based on the principle that data attributable to natural persons may only be used for the purpose for which they were rightfully collected. For example, such a purpose is the provision of a service ordered by a client. In this situation the service provider is the controller, and the client, whose personal data have to be processed, is the data subject. This is called the primary use of data. However, the bulk of such data may have a significant economic value that goes beyond the purpose of the data processing, which can be exploited applying data analysis methods, e.g. with deep learning or other artificial intelligence methods. Data processing having such an analytic or exploitation purpose is called secondary use. Adhering to the principles of personal data protection this is possible in only two distinct cases: if the data subject has given consent to the secondary use, or if the connection between the analyzed data and the data subject has been removed (i.e., in the case of anonymous data).

The prior art contains several technical solutions enabling the secondary use of personal data.

In US 2007/0130070 A1 the objective to be fulfilled is the realization of trading private data between anonymous entities based on encryption and a central entity (“centralized exchange entity”) such that the data exchange can be implemented in a secure environment. In this prior art solution, both the entity offering the data for sale and the identity of the buyer become known in the course of a process called registration. The data are offered for sale in data elements called “indices”, which must be present in the system of a central entity as open data, both when they are uploaded (before being re-encrypted for the buyer) and later when they are searched. If the buyer decides to buy the data, then the central service provider decrypts the data received from the seller in encrypted form, and then re-encrypts them for the buyer. For performing these cryptographic operations, the central service provider receives public encryption keys from the buyer and the seller, but in order to be able to perform the search required for selecting the data it must also obtain the private key of the buyer. Therefore, the central service provider will know the identity of both the seller and the buyer, and will also know every index and the entirety of the traded data, i.e., the invention does not include a protection that would place a limitation on this. In this prior art solution, data protection is optionally entrusted to the preferable properties of an unspecified “sandbox”, i.e., a development environment.

In addition to cryptographic operations, the sandbox described in the document must also support searching in the open index data. The applicability of the circuits designed for executing secure cryptographic operations (Trusted Platform Module (TPM) chip and Hardware Security Module (HSM)) as sandboxes is dubious, because such circuits are adapted for generating cryptographic keys and for performing operations using them. This implies that they are not suitable for managing databases containing significant amounts of data in a protected internal storage space, or for performing searches in large amounts of data. Data protection as described in the known solution (for a small number of records) can be performed applying the sandbox, but in the case of a large number data elements providing the required encryption and decryption capacity may be an impossible task to fulfil. In such a case it is also not possible to detect interrelations between particular records of a large amount of data, as only one (or a few) record(s) would be in unencrypted state at the same time. A basic principle of applying such cryptographic apparatuses is that the private keys must be generated inside them and cannot be read out, i.e., they can only be applied for performing cryptographic mappings. Recognizing the security challenge, the document mentions the possibility to assign the cryptographic operations to an external party, however, it is not presented in the document how this can prevent or reveal a potential fraudulent cooperation between the external party and the central entity.

Disregarding the data protection issues, the solution according to the document presents a good solution to the problem if we have unlimited trust in the reliability of the central service provider. In contrast to that, the objective of the present invention is that the protection of the data exchange be based purely on cryptographic methods, excluding the possibility of involving a trusted third party. It is therefore also not possible to fulfil the objective of the present invention by further improving the known prior art solution, because the steps of the method described therein are fully based on a central entity having functions that cannot be deployed to the entities participating in the data exchange.

US 2007/0162377 A1 discloses an internet portal service where private individuals may sell their data for enterprises seeking to exploit those. The solution does not include any data protection considerations, only giving mention to a possibility thereof, so it is not able to fulfil the objective set before the present invention. The entity providing the portal service acts as a trusted third party, the application of which is excluded by the present invention.

US 2010/0036713 A1 discloses a portal solution wherein personal data are collected by collection systems (mobile phones, navigation systems, personal computers, customer payment systems, etc.) on a personal portal with the purpose of selling the data. Data protection issues arise only in that the data subject may specify in the system the scope of the data that can be used, together with the purpose of use. Adherence to this rule is ensured by the provider of the portal service that acts as a trusted third party, the application of which is excluded from the present invention.

US 2010/0186066 A1 also discloses a solution for personal data propagation. Data exchange between the secure personal data stores and the entities seeking to use the data is implemented in the PDP (Personal Data Propagation) system described in the document, the participants of which are the personal data controller and the client subscribing to personal data. The PDP service keeps a record of the controllers and the subscribers, and verifies the temporal validity and scope of the subscription. In response to a request, the controller compiles the answer and, after the approval by the data subject it fulfils the request. The document primarily describes a business process, only tangentially addressing information technology issues. The controller of the personal data knows the identity of the data subject, storing all its data to be transmitted. In the document, the application of cryptography is suggested only for providing protection against interception and against the unauthorized modification of the data. The document does not provide a solution for a direct, anonymous cooperation between the data subject and the buyer (subscriber) that would be implemented exclusively by cryptographic means.

### DESCRIPTION OF THE INVENTION

The prior art technical solutions require the participation of a trusted third party, implying that the processes and the functions of participants are based on the existence of such a third party, and thus they cannot be further developed in the direction of decentralization due to the limitations of their architecture. According to the present invention, however, instead of data protection based purely on trust a solution based entirely on cryptographic methods becomes available. It has to be noted that the prior art technical solutions require significant-size data stores that are physically and/or cryptographically protected from outside access, a cryptographic key store containing several cryptographic keys, and the participation of a trusted central party. In contrast to that, the present invention allows secure data storage in a public data store, even in a blockchain system, allowing the control over data and ensuring the right of disposal of the data by a mere access to a single private key, while no other participant is required.

The inventive object to be fulfilled is to provide a solution for reusing personal data, wherein the data subject offers the data while preserving its anonymity, while the entity requesting reuse cannot know the identity of the data subject even when it obtains the data, provided that the purchase agreement between them did not stipulate the transfer of person-attributed data. The data subject possesses control of the data also in an information-theoretical sense, i.e., for example the involvement of a central provider is excluded. The data are expediently stored in a public data store; to exercise the right of disposal of all data and to provide proof of such right it is sufficient to possess a single private key. Optionally, the data subject may also issue a statement of consent specifying the purpose of data use. In the case of providing anonymous data this statement is also anonymous, but it is done applying an authentication method that can be performed correctly exclusively by the data subject. Because either the parties or the data cannot be known by a trusted third party, the invention does not require a trusted third party; anonymity and authenticity are ensured by applying purely cryptographic methods.

The technical solution according to the invention will now be presented in sections. In the course of the first process termed “publication”, the data subject places the data in a storage space in such a format that enables a potential reusing entity to decide if it needs them, and, if there is an intention to buy the data, enables the data subject to prove to the interested reusing entity that it offered the data in question, while the anonymity of both the data and the data subject is preserved. To achieve that, the data must be anonymized and masked in such a manner that the reusing entity can establish if it finds the offered data valuable.

In the second process, called “data selection”, the reusing entity selects an element (for example, a record) of the published data that it needs. It then uploads to the storage space such a cryptographic task corresponding to the selected data that can only be solved by the entity that offered the data. The reusing entity expediently also specifies if it needs the data in a person-attributed format, or in a format that in itself is not attributed to a person. Depending on that, the fee payable for the data can optionally be different.

In the third process, termed “data provision”, the data subject uploads the data, together with the solution of the test task, expediently with the consent to data processing, and the preferred mode of payment in such a manner that it can be known solely by the reusing entity.

Besides that, the data subject must make a statement of consent for the use of the data for the given purpose. If it provides the data in an anonymous format, the statement must also be made such that it preserves the anonymity of the data subject. Also in this case, the statement must allow that, in case the data subject accuses the reusing entity of unauthorized data processing, the latter can successfully prove—now knowing the identity of the data subject—that it possesses a consent that could only originate from the data subject in question.

In addition to the data subject, the transferred data must not contain any other identifiable natural persons'data unless their consents are also attached.

The objects of the invention have been fulfilled by the computer implemented method according to claim 1, the computer system according to claim 11, the computer program according to claim 12, and the computer-readable storage medium according to claim 13. Preferred embodiments are defined in the dependent claims.

### BRIEF DESCRIPTION OF THE DRAWINGS

In the following, preferred embodiments of the invention will be described with reference to the following drawings, where

FIG. 1 is a schematic overview diagram of the system according to the invention,

FIG. 2 is a schematic diagram of the data preparation and data publication process,

FIG. 3 is a schematic diagram of the data selection process, and

FIG. 4 is a schematic diagram of the data transfer process.

### MODES FOR CARRYING OUT THE INVENTION

The majority of the data related to natural persons are not controlled by the data subjects themselves. The data controllers are typically service providers that are in contact with the data subjects. According to the principles of data protection, data related to natural persons can only be utilized by the controller for the purposes they were rightfully obtained. However, the data subjects are entitled by legislation to retrieve their data stored by the controller in a widely used, electronic format. Due to the recent progress in the field of data analysis methods and artificial intelligence, the secondary use of data (data analysis) is becoming a more and more pronounced economic interest. This can be achieved either by disconnecting the data from the data subject (through anonymization), or by obtaining the consent of the data subject for processing the data attributable to it. To enable the utilization of data for secondary purposes, the data can for example be written by the data subject to an anonymous database that ensures that the data can be only attributed to a known person with the participation thereof. The invention provides a device that is called a data processing system or alternatively, a data wallet and a technical solution based on the use of the system that enables the data subjects to create an anonymous database. Access to the data—in an open or anonymous format—is requested by the secondary controller based on the properties of the data that are kept in an open format. The data wallet is able to recognize in the anonymous database—without keeping a corresponding record—those data that were encrypted applying a public key generated by it, and is also able to decrypt and compile the data specified in the request and prove by cryptographic means that the consent is given to the data processing by the data subject itself, and is also able to provide the required data. To exercise the right of disposal of the publicly stored data and to provide proof of such right it is sufficient to possess a single private key. The data are encrypted by the data wallet controlled by the data subject in a manner providing that only the given data subject can decrypt them. To protect anonymity, it is preferable to apply different encryption keys for mapping identical values in order to also conceal the fact that they are identical. The solution does not require a cooperating third party, i.e., the communication can be implemented applying a public storage or a decentralized ledger system.

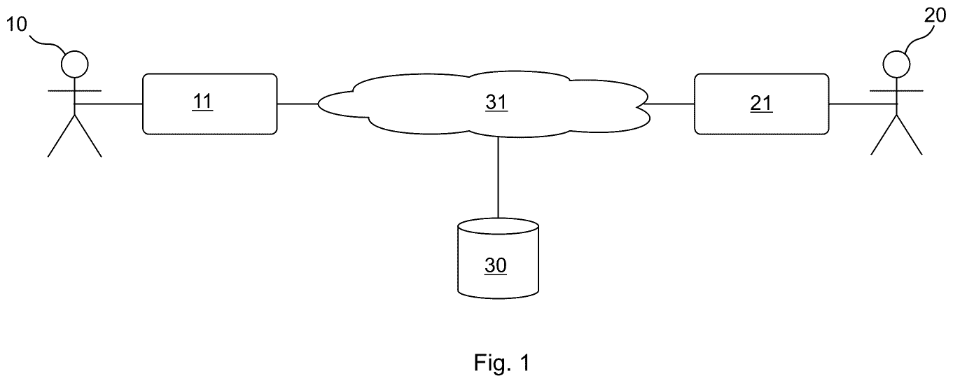

As can be seen in FIG. 1, each data subject 10 has a data processing system 11, in other words, a data wallet, while each reusing entity (data requesting entity 20) has a data request system 21, and both utilize a readable and writable storage space, i.e., a data store 30, preferably via an internet connection 31. The data contained in the data store 30 can be retrieved/read out publicly, but data written by someone else cannot be modified or deleted by any given party. This storage space can also be operated as a decentralized ledger system if we forego the possibility to delete the data. Because the data contained in the storage can only be attributed to the affected data subject by the subject itself, this operation does usually not contradict the principles of processing personal data.

The requirements for the storage space or the data store 30 are that it can be accessed by the users of the system such that they are able to read out all the data contained therein, and are also able to write data thereto. In this system it is not necessary to modify the data. Optionally, it can also be ensured that the affected party may delete the data written by itself. If the latter is not required, then the data store function can even be fulfilled by a blockchain system. In such a decentralized solution, financial incentives can also be provided to motivate the persons participating in operating the system. The data related to all data subjects 10 are stored in a single such storage space, because any internal structure would increase the risk of again attributing them to a particular person. The data subject may even decide to upload the anonymous data to multiple storage spaces, such that they can reach more potential reusing entities.

The computer implemented method according to the invention implements the provision of personal data offered by data subjects 10 to the data requesting entities 20 either anonymously or in a person-attributed manner. Each data subject 10 has a respective assigned data processing system 11, which data processing system 11 has a private key of an asymmetric cryptosystem, and each data requesting entity 20 has an assigned data request system 21, which data request system 21 has a private key of an asymmetric cryptosystem.

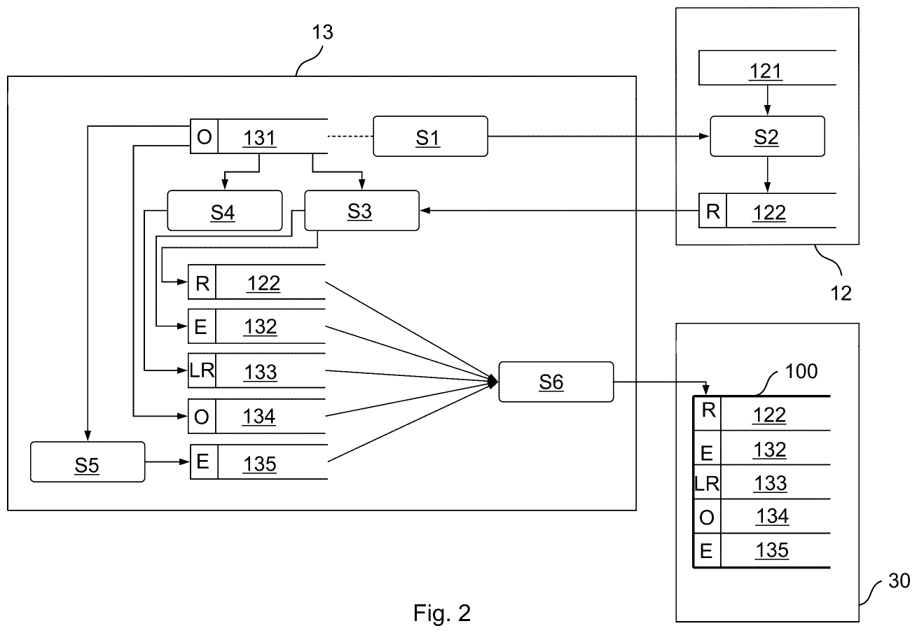

FIG. 2 shows a schematic diagram of the data preparation and publication process. In the figures, different letters denote different types of data elements: open data attributed to a given person are denoted by “O”, anonymous non person-attributed data are denoted by “E”, values derived from not the original personal data are denoted by “R”, and “LR” denotes categorized or low-resolution, i.e., reduced-resolution values. In the course of this process, the anonymous data records 100 generated by the data subjects 10 by means of their data processing systems 11 are collected in a data store 30, and the anonymous data records 100 are made accessible to the data requesting entities 20, where each anonymous data record 100 comprises the following:
a unique public key 122 being generated for the anonymous data record 100 and belonging to the private key 121 of the data processing system 11 of the data subject 10 who generated the anonymous data record 100,
encrypted data 132 generated by encrypting, by means of the unique public key 122, the personal data 131 offered in the anonymous data record 100 by the data subject 10 who generated the anonymous data record 100, and
open data enabling data request selection.

The data publishing process is started by the data subject 10 offering new personal data 131, expediently a new personal data record for reuse. In step S1, the encryption module 13 of the data processing system 11 of the data subject (preferably implemented as a data wallet) requests from the cryptographic key management module of the data wallet 12 a unique public key 122 for the anonymous data record 100 to be generated, which it generates in step S2. Expediently, it is preferable to apply such an asymmetric cryptosystem that allows for generating unique public keys 122 for the single private key 121 in such a number that is sufficient for the number of the offered records.

Encryption of the data enabling the repeated attribution of the data to a person therefore requires the encryption key of an asymmetric key pair. Because the data subjects are natural persons, it is expedient if they can operate the system utilizing minimal infrastructure, for example with the help of a mobile application. Preferably, the cryptographic key management module 12 of the data wallet generates the unique asymmetric public keys 122 such that a single decryption key corresponds to each of them and keeps the generated keys secret. The keys are preferably transferred by the cryptographic key management module 12 to the encryption module 13 of the data wallet.

In step S3, the personal data 131 are encrypted by the encryption module 13 of the data wallet applying this unique public key 122. At the same time it must also be made possible that a reusing entity can receive information about the offered data. To this end, the open data enabling data request selection are applied, which can be specified—for example in step S4—as reduced-resolution data 133 generated from the original data (indicating for example, instead of the exact size: small, medium or large, or instead of the exact date of birth, the year of birth), or data 134 related to the type, characteristics, scope, or to a set or interval of the offered encrypted personal data, or these two can also be applied simultaneously according to the figure for even more effective selection.

More particularly, because the reusing entity, in other words the data requesting entity 20 must be able to establish exactly what has been offered for reuse, so certain properties must be attached to the encrypted data in open form. For example, this can be manifested as the publication of the date or geographical location of an economic event. However, the data specified in such a way should not be suitable for singling out, i.e., it should not be related only to a given natural person, assuming that this uniqueness is a known fact. If uniqueness is not known, then singling out is technically possible, but is not suitable for assigning to a known person. However, if the geographical location is the residential address of a natural person, or for example the date of a car purchase at a given dealer is known, then this additional information can be applied to easily identify the given person. In such a situation it would be appropriate to include the date and place of purchase only at a reduced resolution (i.e., specifying only the month and the county of purchase). The original, high-resolution data must of course also be kept available in the encrypted record.

A hash value 135 characteristic of the original personal data 131, for example, the fields of a personal data record can also be generated applying the data processing system 11 of the data subject 10; for example, a hash value of the concatenated data or fields can be calculated in step S5 and written out together with the other data. Thereby, the data subject 10 will be able to detect any modification of the values written by itself to the data store 30, i.e., the offered data cannot be modified undetectably. Also, in case the data are provided in their entirety, the data requesting entity 20 is able to make sure on the basis of the hash value 135 that it received the originally offered record.

Utilizing the data provider module 14 of the data wallet, the data subject 10 can include in the anonymous data record 100 whether it requests a compensation for the data reuse, or more particularly, the sums it asks for the anonymous and the person-attributed forms.

The anonymous data record 100 is compiled from the above-described elements in step S6, and then it can be written out to (optionally any number of) data stores 30.

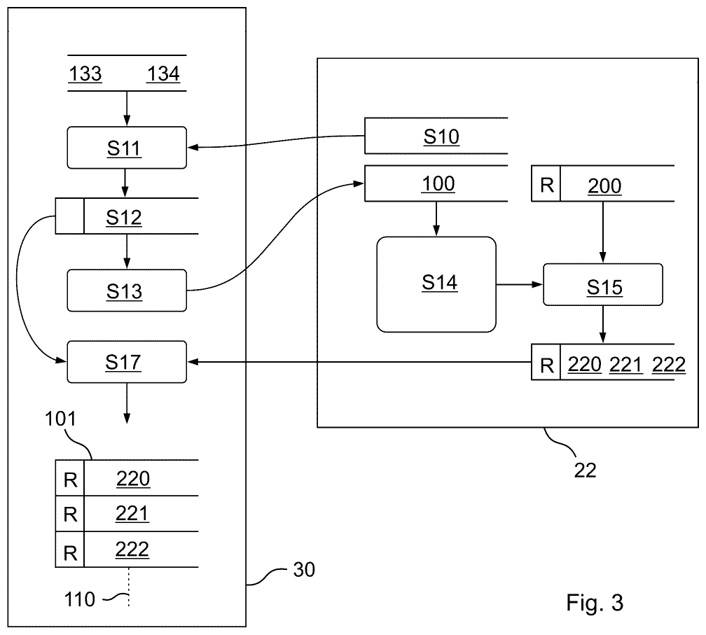

FIG. 3 shows a schematic diagram of the data search and selection process. In the course of their communication, the data subject 10 and the reusing entity (the data requesting entity 20) encrypt their messages applying the other party's public key; such that the reusing entity uses the public key 122 of the record of interest, while the data subject 10 uses the public key 220 specified in the message received from the reusing entity. The data request system 21 of the reusing entity, i.e., of the data requesting entity 20 is implemented as a data query system that comprises a data selection module 22. In step S10, the parameters of the query are specified for the data selection module 22, based on which a selection is performed from among the open data of the anonymous data records 100 held in the data store 30 in step S11. In the course of this, the data meeting the query criteria are identified in step S12. In step S13 the selected anonymous data records 100 are input (one by one) into the data selection module 22. In step S14 it is decided if the given anonymous data record 100 is necessary, and in the affirmative case a challenge value 200 is generated, expediently in the form of a random number, which is then encrypted as a cryptographic task 221 in step S15 applying the public key 122 of the chosen anonymous data record 100.

Thereafter, in step S17, the public key 220 of the data request system 21 is written to the data store 30 as a data request record 101 together with a reference 110 to the given anonymous data record 100, optionally also together with the cryptographic task 221 and the instruction 222 related to the composition of the requested data. The instruction 222 can relate to the scope or format of the requested data, or to the person-attributed provision of the requested data. The reference 110 to the anonymous data record 100 can be for example a unique public key 122 held in the anonymous data record 100, a hash value 135, or any other suitable reference 110, such as in the case of a blockchain implementation, the hash code of the corresponding transaction.

Thus, according to the invention, by also collecting the data request records 101—generated by the data requesting entities 20 by means of their data request systems 21—in a data store 30, the data request records 101 are made available to the data subjects 10, each data request record 101 comprising the following:
a reference 110 to an anonymous data record 100 selected in response to a data request by a search in the open data of the anonymous data records 100 performed by the data request system 21 of the data requesting entity 20 that generated the data request record 101, and
a public key 220 generated for the private key of the data request system 21 of the data requesting entity 20 that generated the data request record 101.

According to the above, the reusable data are therefore identified such that the reusing entity, i.e., the data requesting entity 20 selects—by means of the data selection module 22 of the data query system and on the basis of the open and/or reduced-resolution data linked to the anonymous data records 100 held in the data store 30—the data elements that it needs. Because the data store 30 is preferably publicly readable, this does not constitute a technical problem. The reusing entity then writes a new record, i.e., a data request record 101 to the data store 30 applying a reference 110 (for example the public key 122) that is also suitable for identifying the selected records. In the given case, the data query system may generate a standard asymmetric cryptographic key pair for each selected anonymous data record 100; the data provider module of the data wallet 14 will then utilize the public (encryption) key of this pair such that only the reusing entity can decrypt the provided data written to the data store 30. It is, however, not necessary to generate a different key pair for each case, and it is also possible that the data query system applies a single, permanent key pair. Preferably, the data query system stores in each data request record 101 the parameters of a mathematical task, i.e., an encrypted challenge value 200 in such a manner that it can be solved only by an entity that knows the private key 121 (decryption key) corresponding to the public key 122. This can be performed for example by applying the public key 122 corresponding to the data element for mapping a random number. If a given entity is able to decrypt the random number, then it has proven that it possesses the private key, without disclosing its identity. In addition to that, it preferably also specifies the preferred format of the requested data element, i.e., a person-attributed or anonymous format. The identity of the reusing entity may also be specified (by means of its public key that can be considered anonymous), and the reusing entity may also specify the compensation it offers. These data must also be encrypted applying the public key 122 of the anonymous data record 100, such that they can be read only by the data subject. The data requesting entity 20 is able to specify its request in a person-attributed or in anonymous format.

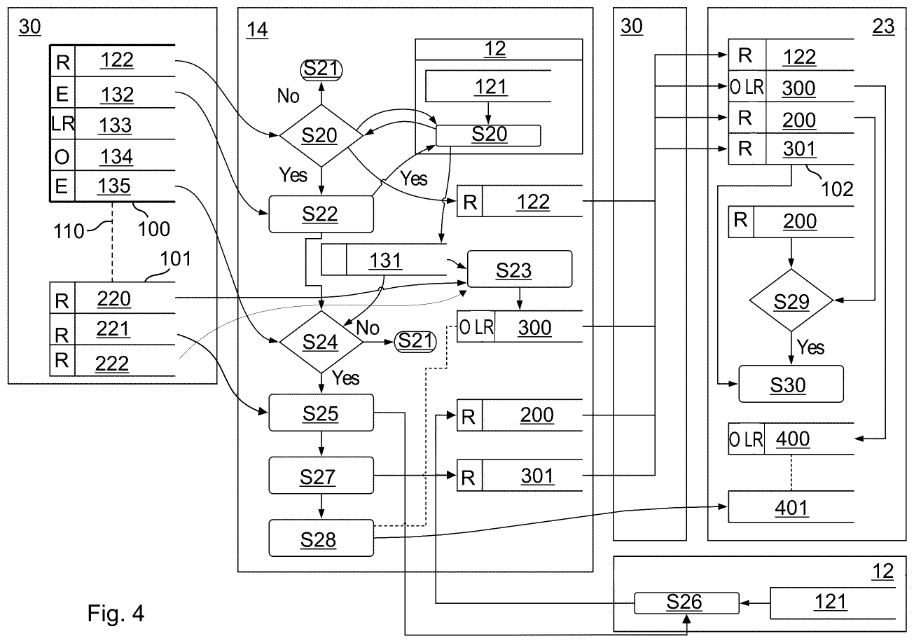

FIG. 4 shows a schematic diagram of the data transfer or data provision process. The data provider module 14 of the data wallet detects in the data store 30 a new record produced by the data selection module 22 of a data query system, i.e., a new data request record 101. In step S20, it checks whether the anonymous data record 100 indicated in the new data request record 101 by the reference 110 is an own one by checking if the result of mapping an arbitrary value applying the public key 122 read out from the anonymous data record 100, and then by its own private key 121 stored in its cryptographic key management module 12 results the value itself. If it is not an own anonymous data record 100, it concludes verification in step S21. If it is an own anonymous data record 100, then in step S22 it applies the private key 121 to generate the non-encrypted offered personal data 131, and in step S23 it produces from those, preferably according to the instruction 222, the requested data, and performs encryption applying the public key 220 of the data requesting entity 20, generating a transferrable encrypted record 300. The encrypted record 300 contains in encrypted form the entirety of the decrypted personal data 131, or the portion thereof specified by the instruction 222. Person-attributed data provision can be implemented for example such that, after the decryption of the encrypted data 132 the data subject 10 passes on the data content also including person-attributed information, which can be for example the entirety of the personal data 131 contained by the anonymous data record 100.

In step S24, the data provider module 14 also checks—by regenerating the hash value 135 from the personal data 131—whether the data held in the data store 30 have been modified or not, and if the data have not been modified, then, preferably by way of mapping step S26, in step S25 it solves the cryptographic task 221 applying its private key 121, which results the challenge value 200. Preferably, in step S27 an anonymous instruction related to financial compensation, for example a crypto wallet address 301 is also generated. Preferably also in step S28, a data subject 401 consent may also be generated.

In the subsequent step, a data provision record 102 is written to the data store 30. By also collecting in the data store 30 the data provision records 102 generated by the data processing systems 11, the records are made accessible to the data requesting entities 20, each data provision record 102 comprising the following:
at least a portion of personal data 131 decrypted from the encrypted data 132 contained in the anonymous data record 100 identified by the data processing system 11 that has recognized an anonymous data record 100 identified based on a reference 110 to an anonymous data record 100 contained in one of the data request records 101 as an own encrypted anonymous data record 100, said data being encrypted applying the public key 220 contained in the data request record 101, and
information ensuring identifiability by the data requesting entity 20 that generated the data request record 101 containing the reference 110 to the identified anonymous data record 100.

The information ensuring identifiability by the data requesting entity 20 can be any suitable information, for example in the case of a blockchain implementation, the hash code of the corresponding transaction, but it can also be expediently one or more of the following:
the public key 220 of the data requesting entity 20,
a reference 110 to the identified anonymous data record 100, such as a unique public key 122 contained in the anonymous data record 100,
a reference to the data request record 101 containing the reference 110 to the identified anonymous data record 100, or
the challenge value 200.

For example, according to FIG. 4 the information ensuring identifiability by the data requesting entity 20 is a unique public key 122 contained by the anonymous data record 100, in addition to which the data provision record 102 shown in the figure also includes the encrypted record 300 to be transferred, the challenge value 200, and the crypto wallet address 301. Based on the public key 122, the corresponding data requesting entity 20 is able to identify and input the data provision record 102, and then it is also able to decrypt the record's contents, primarily the encrypted record 300 utilizing its private key, thereby producing the requested data 400. The data subject consent 401 will cover these requested data 400. Optionally, all information other than the information ensuring identifiability can be included in the data provision record 102 in an encrypted form encrypted with the public key 220, which improves data security.

In step S29, the data reception module 23 of the data query system that has recognized the data provision record 102 as its own checks the solution of the task, and in the affirmative case it initiates payment/compensation in step S30.

Of course, steps S20-S28 are carried out depending on the decision of the data subject 10. If the data subject 10 decides to provide the requested data, then it proves that it has right to make such a decision.

The data provider module 14 of the data subject's 10 data wallet therefore monitors the data requests in the data store 30. Upon detecting a new entry, it checks whether the record referenced to in the entry is an own one. This is preferably implemented by mapping an arbitrary number by the public key 122 read out from the record, followed by mapping it by its own private key 121 and checking whether the original number is obtained. If yes, the public key 122 is an own generated one. Therefore, if it is an own record, the encrypted data of the data element are decrypted to find out who is the requester and for what kind of compensation, and then a decision is made on accepting or rejecting the offer. In the case of an affirmative decision, the data element is generated in the required format. To offer a proof that the data were offered for reuse by the given data subject, it solves the mathematical task utilizing the parameter specified by the data requesting entity. This involves applying its own private key 121 for decrypting the random number encrypted utilizing the public key 122. Optionally, it also specifies the anonymous blockchain wallet address where the financial compensation is expected in crypto assets; in the case of providing person-attributed data, a traditional form of payment can also be specified. The data subject can issue the response by encrypting it utilizing the public key 220 of the data requesting entity, for example in the case of a data element contained in the anonymous database, by marking it with the original public key 122, thereby preserving its anonymity. The reusing entity checks whether the verification number (challenge) linked to the received data element is correct. If the personal data 131 are transferred in the data provision record 102 in their entirety, the data reception module 23 can also check if the hash of the unencrypted personal data 131 returns the hash value 135 included in the anonymous data record 100.

The technical solution according to the invention preferably also comprises issuing a consent of probative value to secondary data processing. The data subject 10 must issue—addressed to the reusing entity, i.e., the data requesting entity 20—the consent to data processing covering the entire data provision process. This can be accomplished for example by signing a statement with the private key 121 corresponding to the public key 122 utilized for the first record of transferred data, the statement specifying the reusing entity and the hash value of the transferred data. The fact that the public key 122 belongs to the data subject can be certified by the primary controller, because it has the information that it received the public key 122 from the data subject 10 who is rightfully known by the primary controller. In the case of anonymous data provision, the consent of the data subject may be necessary because the transferred data are anonymous only in themselves, i.e., in combination with other data they could enable attribution to a natural person. The data subject 10 may consent to this risk in an anonymous statement of which the reusing entity is able to prove that it could be issued solely by the person that had offered the data for reuse. To reduce the risk and to allow legal sanctioning of unauthorized data offers, it can be required that each offered data element be digitally signed with a key that is linked by the certifier to the natural person in such a manner that the identity of the signatory is revealed to a competent authority only in the case of a suspected infringement.

The method according to the invention can be realized, by way of example, as follows.

Key generation for the data wallet: In case an RSA cryptosystem is used, the cryptographic key management module 12 of the data subject's 10 data wallet chooses a secret exponent d falling into a given key size range (having a given bit length), expediently a prime number, such that it is relatively prime with the totient value of any modulus, i.e., it has a corresponding multiplicative inverse. When a public (encryption) key is requested by the encryption module 13 of the data wallet according to the above, it generates a modulus Nᵢ of appropriate size according to the RSA rules, and calculates the inverse eᵢ value corresponding to the secret exponent d. The secret decryption key of the i-th generated key pair will be k_{s,i}=(d, Nᵢ), while the public encryption key thereof will be k_{p,i}=(eᵢ, Nᵢ). The latter will be passed on to the primary controller that generated the anonymous database. It is not necessary to store Nᵢ as it also forms a part of the public key. In such a way, it is possible to issue a practically unlimited number of public keys.

Generation of the anonymous data: The primary controller requests a new k_{p,i}=(eᵢ, Nᵢ) encryption key for each record of the data to be anonymized, and applies it for encrypting the unencrypted record. Utilizing a secure cryptographic hash function it calculates the hᵢ hash value of the unencrypted record. It also compiles the data to be published in open or reduced-resolution format.

Data selection by the reusing entity: After selecting the required records from the anonymous database—based on their open or reduced-resolution properties—the data selection module 22 of the data query system of the reusing entity selects, for each record, a random challenge value rᵢ corresponding to the key size, and maps it utilizing the public key of the record. It also specifies a public key 220 with which the data provider module 14 of the data subject's data wallet will encrypt the data prior to data provision such that they can be decrypted only by the data reception module 23 of the given data query system.

Data provision by the data wallet: The data subject's data wallet checks in the anonymous database if there can be found such a record for which it holds true that the public key k_{p,i}=(eᵢ, Nᵢ) is the inverse of the private key k_{s,i}=(d, Nᵢ). This can be performed by mapping a chosen value utilizing each member of the key pair. If the original value is returned, then it is an own key pair. In the case of such records, it can remove the encryption applying the private key k_{s,i}=(d, Nᵢ).

Operation of the data reception module 23 of the data query system: This module is adapted for retrieving from the data store 30 the data encrypted with its own public key 220. After removing the encryption, it checks whether the solution of the task by the data provider module 14 of the data subject's data wallet is correct, verifies the authenticity of the data subject's consent, and makes the payment.

The technical solution according to the invention can also be realized such that the transferred data are anonymous, which implies that the consent to data processing is also anonymous. This is implemented by certifying the connection of the public key 122 utilized by the data wallet and the data subject 10 by a signature certifier.

Preferably, the anonymous data records 100, the data request records 101 and the data provision records 102 are collected and made available in the same open data store 30.

Another aspect of the invention is a computer program comprising instructions which, when the program is executed by a computer, cause the computer to carry out the method according to the invention. Furthermore, the invention is a computer-readable storage medium having stored thereon the above-described computer program.

The modules of the method and system according to the invention can be implemented exclusively in software, but can also be a software-hardware combination. The data requesting entities 20 can be natural persons, legal persons, or any other entities with a demand for data reuse.

1. A computer implemented method for providing either anonymously or in a person-attributed manner personal data, offered by data subjects, to data requesting entities, characterized in that each data subject has a respective assigned data processing system, wherein the data processing system has a private key of an asymmetric cryptosystem, each data requesting entity having a respective assigned data request system, said data request system having a private key of an asymmetric cryptosystem, and with the method comprising the following steps:
making available anonymous data records to the data requesting entities by collecting, in a data store, the anonymous data records generated by the data subjects by means of their data processing systems, each anonymous data record comprising the following:
a unique public key being generated for the anonymous data record and belonging to the private key of the data processing system of the data subject who generated the anonymous data record,
encrypted data generated by encrypting, by means of the unique public key, the personal data offered in the anonymous data record by the data subject who generated the anonymous data record, and
open data enabling data request selection,
furthermore, making available data request records to the data subjects by also collecting, in a data store, the data request records generated by the data requesting entities by means of their data request systems, each data request record comprising the following:
a reference to an anonymous data record selected in response to a data request by a search in the open data of the anonymous data records performed by the data request system of the data requesting entity that generated the data request record, and
a public key generated for the private key of the data request system of the data requesting entity that generated the data request record,
and making available data provision records to the data requesting entities, by also collecting, in a data store, the data provision records generated by the data processing systems, each data provision record comprising the following:
at least a portion of personal data decrypted from encrypted data contained in an anonymous data record identified by the data processing system that has recognized the anonymous data record identified based on a reference to the anonymous data record contained in one of the data request records as an own encrypted anonymous data record, said data being encrypted applying the public key included in the data request record, and
information ensuring identifiability by the data requesting entity that generated the data request record containing the reference to the identified anonymous data record.

2. The method according to claim 1, characterized in that the open data contained in the anonymous data record are data related to the type, characteristics, scope, or to a set or an interval of the encrypted personal data offered in the anonymous data record, or are reduced-resolution data.

3. The method according to claim 1, characterized in that the data processing system is implemented as a data wallet system having a cryptographic key management module, an encryption module , and a data provider module, and
the unique public key in the anonymous data record is generated on the basis of a private key in the cryptographic key management module and is passed on to the encryption module,
the encrypted data in the anonymous data record are encrypted applying the encryption module, and the anonymous data record is written to a data store by means of the encryption module, and
the data provision records are generated and written to a data store by the data provider module.

4. The method according to claim 1, characterized in that the data request system is implemented as a query system comprising a data selection module and a data reception module, and
the anonymous data records are selected for data query by a search performed in the open data of the anonymous data records by the data selection module, and the data request records are generated and written to a data store by the data selection module, and
the data provision records are read out from a data store by means of the data reception module.

5. The method according to claim 1, characterized in that the reference in the data request record is a unique public key in the anonymous data record.

6. The method according to claim 1, characterized in that the data request record further comprises an instruction related to the scope of the requested data, to the format of the requested data, or to providing the requested data in a person-attributed manner, and the requested data are compiled in the corresponding data provision record according to said instruction.

7. The method according to claim 1, characterized in that the data request record further comprises a challenge value encrypted by means of a unique public key contained in the anonymous data record referred to by the reference, and the corresponding data provision record contains, in an open format or encrypted by means of the public key contained by the data request record, the challenge value decrypted by the data processing system that has recognised the anonymous data record as an own encrypted anonymous data record.

8. The method according to claim 1, characterized in that the data provision record further comprises an anonymous instruction related to a compensation, for example a crypto wallet address.

9. The method according to claim 1, characterized in that the anonymous data records, the data request records, and the data provision records are collected and are made available in the same open data store.

10. The method according to claim 1, characterized in that the information ensuring identifiability by the data requesting entity is
the public key of the data requesting entity,
a reference to the identified anonymous data record, such as a unique public key contained in the anonymous data record,
a reference to the data request record containing the reference to the identified anonymous data record, or
a challenge value.

11. A computer system for providing either anonymously or in a person-attributed manner personal data, offered by data subjects, to data requesting entities, characterized by comprising
a data processing system for each data subject, the data processing system having a private key of an asymmetric cryptosystem,
a data request system for each data requesting entity, the data request system having a private key of an asymmetric cryptosystem,
with anonymous data records generated by the data subjects by means of their data processing systems and collected in a data store and made available to the data requesting entities, each anonymous data record comprising the following:
a unique public key being generated for the anonymous data record and belonging to the private key of the data processing system of the data subject who generated the anonymous data record,
encrypted data generated by encrypting, by means of the unique public key, the personal data offered in the anonymous data record by the data subject who generated the anonymous data record, and
open data enabling data request selection,
with data request records generated by the data requesting entities by means of their data request systems and collected in a data store and made available to the data subjects, each data request record comprising the following:
a reference to an anonymous data record selected in response to a data request by a search in the open data of the anonymous data records performed by the data request system of the data requesting entity that generated the data request record, and
a public key generated for the private key of the data request system of the data requesting entity that generated the data request record,
and
with data provision records generated by the data processing systems and collected in a data store and made available to the data requesting entities, each data provision record comprising the following:
at least a portion of personal data decrypted from encrypted data contained in an anonymous data record identified by the data processing system that has recognized the anonymous data record identified based on a reference to the anonymous data record contained in one of the data request records as an own encrypted anonymous data record, said data being encrypted applying the public key included in the data request record, and
information ensuring identifiability by the data requesting entity that generated the data request record containing the reference to the identified anonymous data record.

12. A computer program comprising instructions which, when the program is executed by a computer, cause the computer to carry out the method according to claim 1.

13. A computer-readable storage medium having stored thereon the computer program according to claim 12.
